(19) United States
(12) Patent Application Publication
(10) Pub. No.: US 2024/0417308 A1
(43) Pub. Date: Dec. 19, 2024

(54) TITANIA-SILICA GLASS WITH PLURALITY OF COMPOSITIONAL VARIATION SECTIONS

(71) Applicant: CORNING INCORPORATED, CORNING, NY (US)

(72) Inventors: William Robert Angell, IV, Painted Post, NY (US); John Edward Maxon, Canton, NY (US)

(21) Appl. No.: 18/678,834

(22) Filed: May 30, 2024

Related U.S. Application Data
(60) Provisional application No. 63/521,766, filed on Jun. 19, 2023.

(51) Int. Cl. C03C 3/076; C03B 19/14

(52) U.S. Cl. CPC C03C 3/076; C03B 19/1423; C03B 2201/42; C03B 2207/34; C03B 2225/00; C03C 2201/42

(57) ABSTRACT

A titania and silica glass body that includes a first glass section having a crossover temperature of about 10° C. to about 60° C. and a second glass section comprising an average striae height of about 10 microns or less, wherein the average striae height of the second glass section is less than an average striae height of the first glass section, and wherein the first glass section and the second glass section form a single, monolithic glass body.

This application claims the benefit of priority under 35 U.S.C § 120 of U.S. Provisional Application Ser. No. 63/521,766 filed on Jun. 19, 2023, the content of which is relied upon and incorporated herein by reference in its entirety.

### FIELD

The present disclosure is directed to titania-silica glass with a plurality of compositional variation sections and methods of making thereof, and more specifically to titania-silica glass with at least two sections having different striae content due to their compositional variation. The produced glass article may be suitable for use in extreme ultraviolet lithography applications.

### BACKGROUND

Extreme ultraviolet (EUV) lithography uses optics to illuminate, project, and reduce pattern images to form integrated circuit patterns. The use of extreme ultraviolet radiation is beneficial in that smaller integrated circuit features can be achieved. The optics for EUV lithography are currently made from low thermal expansion glass, such as silica-titania glass. The glass is traditionally made by a flame hydrolysis process in which high purity precursors are injected into flames to form fine glass particles that are then deposited onto a glass body.

In EUV lithography systems, the glass is typically coated with a reflective surface to form a reflective mirror or photomask. Furthermore, the glass, in an EUV lithography system, must be able to meet stringent thermal expansion requirements in the system. Specifically, the glass must be able to maintain its surface shape (known as “figure”) when subject to temperature changes in the system. A temperature stable glass is necessary to avoid any induced distortions in the wavefront characteristics of EUV projection optics. Furthermore, the glass should be able to polish to the stringent requirements needed for EUV lithography systems.

### SUMMARY

Embodiments of the present disclosure comprise methods to produce glass bodies that are able to advantageously maintain their figure during operation of an EUV lithography system. Therefore, the glass bodies, according to the embodiments of the present disclosure, reduce or prevent any distortions in the wavefront characteristics of EUV projection optics. Furthermore, the embodiments of the present disclosure produce glass bodies have high polishing capabilities.

According to aspects of the present disclosure, a titania and silica glass body is disclosed comprising a first glass section having a crossover temperature of about 10° C. to about 60° C. and a second glass section comprising an average striae height of about 10 microns or less, wherein the average striae height of the second glass section is less than an average striae height of the first glass section, and wherein the first glass section and the second glass section form a single, monolithic glass body.

According to aspects of the present disclosure, a method of producing a glass body is disclosed, the method comprising ejecting titania-silica soot particle droplets from a burner of a furnace in a collection cup, the titania-silica soot particle droplets being ejected in a laydown pattern in the collection cup to form a first glass section, modifying the laydown pattern of the titania-silica soot particle droplets to form a second glass section, consolidating the titania-silica soot particle droplets in the collection cup, wherein the first glass section and the second glass section comprise a single, monolithic glass body, and wherein the average striae height of the second glass section is less than an average striae height of the first glass section.

### BRIEF DESCRIPTION OF THE DRAWINGS

While the specification concludes with claims particularly pointing out and distinctly claiming the subject matter of the description, it is believed that the description will be better understood from the following specification when taken in conjunction with the accompanying drawings.

FIG. 1A shows a composite glass body with first and second glass sections, according to embodiments disclosed herein;

FIG. 1B shows the composite glass body of FIG. 1A with individual deposition layers, according to embodiments disclosed herein;

FIG. 2A is a schematic illustration of a system to produce the glass body of FIG. 1A, according to the embodiments disclosed herein;

FIG. 2B shows an enlarged schematic of the burners and collection cup of the system of FIG. 2A, according to the embodiments disclosed herein;

FIG. 2C shows an oscillation laydown pattern using the system of FIGS. 2A and 2B, according to the embodiments disclosed herein;

FIG. 3 is a plot of optical retardation vs. length of glass, according to the embodiments disclosed herein;

FIG. 4A shows an exemplary glass body with a sample therein, according to embodiments disclosed herein;

FIG. 4B shows a cross-section of the sample of the glass body of FIG. 4A, according to embodiments disclosed herein; and

FIG. 4C shows another cross-section of the sample of the glass body of FIG. 4A with an outer, peripheral lip, according to embodiments disclosed herein.

### DETAILED DISCLOSURE

As used herein, “ppm” means parts per million by weight.

As used herein, “atm” means atmosphere.

As used herein, the term “glass composite” refers to a glass body having at least two glass sections that differ in compositional variation such that the at least two glass sections each remain as separate and distinct sections in the finished structure of the glass body. By differing in compositional variation, the at least two glass section comprise a variation in at least one compositional element, such as the variation in the deposition of that compositional element. However, as discussed further below, the finished glass body (with the at least two glass sections) is one, monolithic body. Therefore, the at least two glass sections are not bonded together in order to produce the finished glass body.

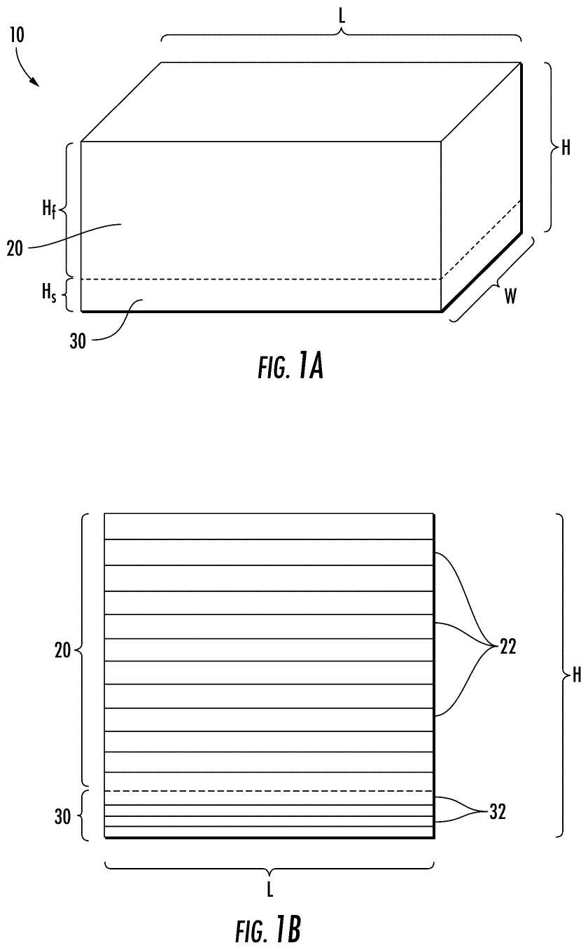

FIG. 1A shows an exemplary glass body 10, produced according to the embodiments disclosed herein, that is suitable for the use in EUV lithography applications. Glass body 10 is a glass composite that comprises titania-doped silica glass. As shown in FIG. 1A, glass body 10 comprises at least a first glass section 20 and a second glass section 30. First glass section 20 comprises a different compositional variation of at least one compositional element from second glass section 30. In some embodiments, as discussed further below, due to the different compositional variation, first glass section 20 has relatively more uniform thermal expansion properties than second glass section 30 so that first glass section 20 is able to maintain its shape and figure even when subjected to the demanding thermal loads of EUV systems. Second glass section 30, due to the different compositional variation, has a higher polishing capability so that it is able to polish to a smoother finish.

EUV lithography technology relies on an optical projection system to expose a reflective mirror and/or photomask with EUV light, such that light reflected from the mirror and/or photomask is directed to a thin photosensitive layer deposited on the surface of a semiconductor wafer. This technique is commonly used in the semiconductor device production process. EUV lithography systems operate at a wavelength of light of about 13.5 nm. This extremely short wavelength poses a number of challenges to the design of EUV systems. For example, reflective coatings on the bodies of the mirror and/or photomask in EUV systems are not able to reflect all of the light with such a low wavelength. About thirty percent of the light is absorbed by the reflective coatings, rather than reflected. The absorbed light produces undesirable heat in the glass body, causing the glass body to thermally expand or contract. Such changes in the glass body can in turn cause the reflective coating, on the glass body, to deform, which leads to distortions in the wavefront of the reflected light. Wavefront distortions may lead to deterioration in the resolution of the EUV system and errors in the patterns formed on the photosensitive layer.

Coefficient of thermal expansion (CTE), as is known in the art, is a material property of glass that is indicative of the extent to which the material expands (changes shape) when heated. Therefore, lower CTE values advantageously allow the glass body to not change shape when exposed to different temperature environments, which as discussed above, is beneficial in lithography applications. Furthermore, a glass body with uniform CTE values throughout will expand evenly when heated. It is beneficial for a glass body in an EUV system to comprise both uniform and low CTE values. First section 20 of glass body 10 comprises such uniform and low CTE values. In particular, first glass section 20 of glass body 10 comprises uniform expansion properties in a radial (lengthwise) direction of the glass body. However, one consequence of the radial uniform expansion properties of first glass section 20 is that this glass section contains striae. As is known in the art, striae are compositional inhomogeneities in an axial direction of the glass body. Therefore, although first glass section 20 comprises radial uniformity, it does not comprise such axial uniformity.

Striae can be a result of thermal variations of the growing glass as the fine particles are deposited. The occurrence of striae in the glass results in thin alternating layers of glass with different CTE values and, therefore, alternating planes of compression and tension within each layer. The inclusion of striae in glass can impact surface finish of the glass at an angstrom root mean square (rms) level, which can adversely affect the polishability of the glass. More specifically, polishing glass that contains striae can result in unequal material removal, which in turn results in increased surface roughness. This can be problematic for stringent applications like EUV lithography articles. For example, polishing glass containing striae may result in a mid-frequency surface structure on the glass that can cause image degradation, for example when the glass is used in mirrors in EUV lithography projection systems.

Glass body 10 thus comprises second glass section 30, which comprises a reduction in striae as compared to first glass second 20. Second glass section 30, therefore, has a much better polishing capability than first section 20 so that second glass section 30 is able to polish to a smoother surface with a lower surface roughness. Aspects of the present disclosure include glass body 10 that comprises both first glass section 20, which comprises advantageous uniform expansion properties, and second glass section 30, which comprises advantageous polishing properties, in a monolithic glass body. In embodiments, second glass section 30 is removed (either completely or in part) with the machining and/or polishing of the glass. With both first and second glass sections 20, 30, glass body 10 is able to have the advantageous radial uniform expansion properties while still being capable of polishing to the stringent smoothness required for EUV applications. Furthermore, glass body 10 is a monolithic body so that the time and expense to adhere two different glass sections is avoided.

With reference again to FIG. 1A, glass body 10 is a boule and may comprise a length L, a width, W, and a height H. In embodiments, the length L and the width W of glass body 10 are each from about 20 mm to about 2000 mm, or about 40 mm to about 1500 mm, or about 60 mm to about 1000 mm, or about 80 mm to about 800 mm, or about 100 mm to about 60 mm, or about 20 mm to about 40 mm. The length L and the width W can the same or different from each other. Furthermore, in some embodiments, the height H of glass body 10 is about 50 mm to about 500 mm, or about 60 mm to about 400 mm, or about 80 mm to about 200 mm, or about 100 mm to about 200 mm, or about 250 mm to about 500 mm, or about 250 mm to about 400 mm, or about 250 mm to about 300 mm, or about 200 mm to about 500 mm, or about 200 mm to about 400 mm, or about 200 mm to about 300 mm. However, it is noted that the length L, width W, and height H of glass body 10 can vary and are not limited by the embodiments disclosed herein. It is also noted that in some embodiments, the length L is larger than the height H of glass body 10, while in other embodiments the height H is larger than the length L.

In embodiments, glass body 00 has a mass of about 20 kg or greater, or about 30 kg or greater, or about 50 kg or greater, or about 100 kg or greater, or about 150 kg or greater, or about 200 kg or greater or about 300 kg or greater, or about 400 kg or greater, or about 500 kg or greater. Although FIG. 1A depicts glass body 10 as rectangular, it is contemplated that glass body 10 may comprise other shapes such as, for example circular or oval. Glass body 10 may be non-symmetrical. It is also contemplated that one or more surfaces of glass body 10 to be curved (e.g., concave or convex).

Furthermore, first glass section 20 has a height H_{f} and second glass section 30 has a height H. It is noted that the length and width of each of first glass section 20 and second glass section 30 are the same as the length L and width W of glass body 10. In embodiments, the height H_{f} of first glass section 20 is about 60% or more of the entire height H of glass body 10, or about 70% or more, or about 80% or more, or about 90% or more, or about 95% or more, or about 99% or more. Therefore, the height H_{f} of first glass section 20 may be greater than the height H_{b} of second section 30. A summation of the height H_{f} of first glass section 20 and the height Hₛ of second glass section 30 may be equal to the total height H of glass body 10 (so that glass body 10 does not comprise any other members along its height H). The height Hₛ of second glass section 30, in embodiments, is about 1 mm to about 250 mm, or about 2 mm to about 200 mm, or about 4 mm to about 150 mm, or about 6 mm to about 100 mm, or about 8 mm to about 10 mm to about 75 mm, or about 15 mm to about 50 mm, or about 20 mm to about 35 mm, or about 25 mm to about 125 mm, or about 50 mm to about 100.

As discussed above, glass body 10 may be a monolithic member such that first glass section 20 and second glass section 30 are not bonded together. Instead, they consist of the same unitary member. Therefore, a seal is not formed or present between first and second glass sections 20, 30. Such a seal would be formed between two glass sections that are separately formed and then bonded together, thus creating a seal plane at the bonding interface. However, embodiments of the present disclosure do not comprise such a seal plane.

It is also noted that embodiments of the present disclosure include wherein glass body 10 comprises one or more additional glass sections in addition to first glass section 20 and second glass section 30. In such embodiments, glass body 10 still comprises a monolithic (unitary member) formed of first and second glass sections 20, 30 and the additional glass sections.

Although FIG. 1A shows a distinct and definite boundary line between first glass section 20 and second glass section 30, it is noted that the boundary may not be as such in reality. For example, the boundary between first glass section 20 and second glass section 30 may waver and oscillate. In some embodiments, the boundary between these two sections may be a gradient such that first glass section 20 progressively transitions into second glass section 30.

Both first glass section 20 and second glass section 30 comprise silica glass doped with titania. The concentration of silica in each of first glass section 20 and second glass section 30 is about 80 wt. % or more, or about 85 wt. % or more, or about 90 wt. % or more, or about 92 wt. % or more, or about 95 wt. % or more, or about 97 wt. % or more, or about 98 wt. % or more, or about 99 wt. % or more, or from about 85 wt. % to about 97 wt. %, or from about 90 wt. % to about 95 wt. %. The titania concentration in each of first glass section 20 and second glass section 30 is from about 1.0 wt. % to about 15.0 wt. %, or from about 6.0 wt. % to about 12.0 wt. %, or from about 6.0 wt. % to about 8.5 wt. %, or from about 6.0 wt. % to about 8.0 wt. %, or from about 6.0 wt. % to about 7.5 wt. %, or from about 6.0 wt. % to about 7.0 wt. %, or about 6.0 wt. % to about 6.8 wt. %, or about 6.0 wt. % to about 6.5 wt. %. First glass section 20 may have different concentrations of silica and/or titania than second glass section 30.

Both first section 20 and second section 30 comprise a CTE of about −30 ppb/° C. to about +30 ppb/° C. within the temperature range between 15° C. and 30° C. In some embodiments the CTE is about −10 ppb/° C. to about +10 ppb/° C. within the temperature range between 15° C. and 30° C., or about −5 ppb/° C. to about +5 ppb/° C. within the temperature range between 15° C. and 30° C., or about −2 ppb/° C. to about +2 ppb/° C. within the temperature range between 15° C. and 30° C., or about −1 ppb/° C. to about +1 ppb/° C. within the temperature range between 15° C. and 30° C., or about 0 ppb/° C. at a temperature between 15° C. and 30° C. The CTE of first glass section 20 may be the same or different from the CTE of second glass section 30. Such ultralow CTE values at room temperature (or at about room temperature) allow the shape of glass body 10, whether formed into a mirror or a photomask (such as a reflective mask), to remain substantially constant upon heating, during the EUV lithography process. For purposes disclosed herein, the CTE was measured using a Zygo optical interferometer (specifically, a Zygo MST HDX with a 4″ aperture).

In embodiments, both first glass section 20 and second glass section 30 comprise a crossover temperature (Tzc) in a range from about 10° C. to about 60° C., or from about 20° C. to about 40° C., or from about 20° C. to about 38° C., or from about 22° C. to about 38° C. In embodiments, first glass section 20 and second glass section 30 comprise a crossover temperature of about 20° C. to about 60° C., or from about 25° C. to about 55° C., or from about 30° C. to about 50° C., or from about 35° C. to about 45° C., or from about 40° C. to about 45° C., or from about 20° C. to about 45° C., or from about 20° C. to about 40° C., or from about 10° C. to about 50° C.

The crossover temperature of first glass section 20 may be the same or different from the crossover temperature of second glass section 30. The crossover temperature is the temperature at which the CTE of the glass is exactly zero. When glass body 10 is utilized in EUV lithography applications, the crossover temperature is ideally within the temperatures that the glass body is expected to experience, in order to minimize thermal expansion of the glass substrate during the lithography process. Designers of EUV lithography systems calculate an optimum crossover temperature for each glass body 10 in the system, based on the thermal load, size, and heat removal rates afforded by the system. The crossover temperature of glass body 10 is additionally determined by the techniques disclosed in U.S. Pat. No. 10,458,936, which is incorporated by reference herein.

Furthermore, first glass section 20 and second glass section 30 each have a slope of CTE at 20° C. in a range from about 1.0 ppb/K² to about 2.5 ppb/K², or about 1.15 ppb/K² to about 2.0 ppb/K², or about 1.2 ppb/K² to about 1.9 ppb/K², or about 1.3 ppb/K² to about 1.7 ppb/K², or about 1.6 ppb/K² to about 2.2 ppb/K² or about 1.7 ppb/K² to about 2.0 ppb/K², or about 1.8 ppb/K² to about 1.9 ppb/K². The slope of CTE is the rate of change of the CTE of the glass as a function of the temperature of the glass. When glass body 10 is utilized in EUV lithography applications, the slope of CTE is ideally minimized so that the glass body experiences minimal thermal expansion caused by fluctuations in the temperature of the glass body during the EUV lithography process. CTE slope is additionally measured by the techniques disclosed in aforementioned U.S. Pat. No. 10,458,936.

Although first glass section 20 and second glass section 30 have similar chemical compositions, these sections comprise different compositional variation. In particular, the titania deposition varies between first glass section 20 and second glass section 30, which is a result of the different processes to form these different glass sections. First glass section 20 may be formed by a deposition process that produces relatively thicker titania deposition layers (along height H) as compared with second glass section 30. As shown in FIG. 1B, the individual titania deposition layers 22 of first glass section 20 are each thicker than the individual titania deposition layers 32 of second glass section 30. The relatively thicker deposition layers 22 of first glass section 20 allows the layers to have more uniform titania concentrations along the length L of each layer, resulting in higher CTE uniformity along the length L. Therefore, layers 22 are able to expand and contract uniformly so that first glass section 20 maintains its shape when heated within an EUV system. However, first glass section 20 comprises relatively more striae than second glass section 30.

As noted above, striae are variations in the homogeneity of the glass body and adversely affect the polishability of the glass. In particular, striae are nonuniformities between the different deposition layers. As an example, a first deposition layer may have a slightly different concentration of titania from a second and adjacent deposition layer resulting in nonuniformity between these layers. Therefore, striae are nonuniformities along the height H of glass body 10.

Second glass section 30 comprises relatively thinner titania deposition layers than first glass section 20. Due to the thinner layers, the titania compounds within each individual deposition layer 32 diffuse together. The relatively thin deposition layers 32 within second glass section 30 allow such diffusion. It is noted that such diffusion does not occur with relatively thicker deposition layers. Because the titania compounds diffuse together between the different deposition layers 32 in second glass section 30, these different deposition layers 32 have very uniform titania concentrations between the different layers, resulting in a very low striae content.

Stated another way, each of the individual deposition layers 32 in second glass section 30 comprise the same (or approximately the same) concentration of titania. Therefore, second glass section 30 has a very high polishing capability.

It is noted that although second glass section 30 comprises a reduced striae content compared with first glass section 20, second glass section 30 is not as uniform across the length L of each deposition layer. Therefore, as discussed above, first glass section 20 has a more uniform titania concentration across the length L of each layer, whereas second glass section 30 has a more uniform titania concentration between the different layers. As a result, first glass section 10 has a higher CTE uniformity along the length L of glass body 10 (so that it maintains its shape when heated) but second glass section 30 polishes to a higher smoothness.

As discussed above, second glass section 30 comprises less striae than first glass section 20. The content or amount of striae in each section is measured by the magnitude of the striae, which includes the size (e.g., average height) of the striae and the spacing between adjacent striae. The size of the striae, as disclosed herein, comprises the height of the striae as measured in a direction along the height H of glass body 10. The spacing between adjacent striae, as disclosed herein, comprises the spacing between adjacent striae in a direction along the length L of glass body 10. Second glass section 30 comprises striae with a reduced size (average height) and with reduced spacing between adjacent striae as compared to first section 20. Therefore, second glass section 30 polishes more evenly along its length as compared to first glass section 20. It is noted that smaller striae and striae that are closer together (so that the titania nonuniformities are smaller and closer together) more easily allow the titania compounds to diffuse together so that the striae is no longer detectable as compared with larger striae and striae that are further apart.

In embodiments, the average striae height in first glass section 20 and throughout the entire length of first glass section 20 is in a range from about 10 microns to about 30 microns, or about 12 microns to about 28 microns, or about 15 microns to about 25 microns, or about 28 microns to about 22 microns, or about 24 microns to about 26 microns.

Conversely, the average striae height in second glass section 30 is less than the average striae height in first glass section 20. In embodiments, the average striae height in second glass section 30 is about 1 micron or less, or about 0.75 microns or less, or about 0.50 microns or less, or about 0.25 microns or less, or about 0.10 microns or less, or about 80 nm or less, or about 60 nm or less, or about 50 nm or less, or about 40 nm or less, or about 20 nm or less, or about 10 nm or less, or about 5 nm or less, or about 1 nm or less. In some embodiments, second glass section 30 does not comprise striae (or the striae is so small that it is undetectable) so that the average striae height in second glass section 30 is 0.00 nm.

Furthermore, in embodiments, the average spacing between adjacent striae in first glass section 20 and throughout the entire length of first glass section 20 is about 1.00 mm or less, or about 0.80 mm or less, or about 0.75 mm or less, or about 0.60 mm or less, or about 0.50 mm or less, or about 0.55 mm or less, or about 0.50 mm or less, or about 0.45 mm or less, or about 0.40 mm or less, or about 0.35 mm or less, or about 0.30 mm or less, or about 0.25 mm or less, or about 0.20 mm or less, or about 0.15 mm or less, or about 0.1 mm or less, or about 75 microns or less, or about 50 microns or less, or about 25 microns or less, or about 10 microns or less. In some embodiments, the spacing in first glass section 20 is in a range from about 0.10 mm to about 0.55 mm, or about 0.15 mm to about 0.50 mm, or about 0.2 mm to about 0.40 mm, or about 0.25 mm to about 0.35 mm, or any combination of these endpoints.

Conversely, the average spacing between adjacent striae in second glass section 30 is less than the average spacing between adjacent striae in first glass section 20. In embodiments, the average spacing between adjacent striae in second glass section 30 is about 10 microns or less, or about 8 microns or less, or about 5 microns or less, or about 4 microns or less, or about 2 microns or less, or about 1 micron or less, or about 0.75 microns or less, or about 0.50 microns or less, or about 0.25 microns or less, or about 0.10 microns or less, or about 80 nm or less, or about 60 nm or less, or about 50 nm or less, or about 40 nm or less, or about 20 nm or less, or about 10 nm or less, or about 5 nm or less, or about 1 nm or less. In some embodiments, second glass section 30 does not comprise striae (or the striae is so small that it is undetectable) so that the average spacing between striae is undetectable.

The height of the striae and the spacing between adjacent striae, as used herein, is calculated based upon the concentration of titania in the glass. And the concentration of titania in the glass is determined using a microprobe analyzer. In particular, the glass samples for analysis with the microprobe analyzer are first prepared as polished cross-sections and a conductive carbon coating is evaporated on the polished surface. Electron probe micro-analyzer (EPMA) analyses are performed on the glass samples using a JEOL 8500F Hyperprobe (2008) electron microprobe analyzer. This microprobe analyzer quantifies measurements from a titanium K-alpha x-ray line using a pentaerythritol (PET) diffracting element in a wavelength dispersive spectrometer. A micro-TiO₂, rutile form standard in the 53 minerals standard block (Serial No. 99-143 from Structure Probe Inc., West Chester Pa) is used to peak the spectrometer position and calibrate the number of Ti K-alpha x-ray measurements at a known electron beam current and time. Typical beam parameters used for analyses are 15 keV accelerating potential at 50-100 nA beam current with on-peak count times ranging from 10-30 seconds. Beam current and count times can be changed to greater or lesser values depending on the titanium concentration and/or precision needed for the analyses. Line scan or point analyses are performed on the glass samples using either a focused or defocused beam where the beam spot size is determined based upon the size of the feature of interest (e.g. focused or 1 um spot for striae, defocused 10-20 um spot for homogeneity) and stepped across the region of interest at a step size dictated by the size of the feature of interest. Results are reported as weight percent oxide assuming stoichiometry.

The magnitude of the striae (the average height of the striae and the average spacing between adjacent striae) is directly related to optical retardation of the glass body. A glass body with striae having a smaller average height and with smaller spacing between adjacent striae would have smaller optical retardation. Because second glass section 30 of glass body 10 comprises striae with a relatively lower magnitude than first glass section 20, second glass section 30 of glass body 10 has relatively smaller optical retardation than first section 20.

In some embodiments, second glass section 30 is machined or polished from glass body 10 before further downstream processing. The entirety of second glass section 30 or less than the entirety of second glass section 30 may be machined or polished off. For example, second glass section 30 may be machined or polished until only about 10 mm or less in height remains of second glass section 30, or about 8 mm or less in height, or about 5 mm or less in height, or about 2 mm or less in height, or about 1 mm or less in height, or about 0.2 mm or less in height, or about 0.1 mm or less in height or about 0.05 mm or less in height.

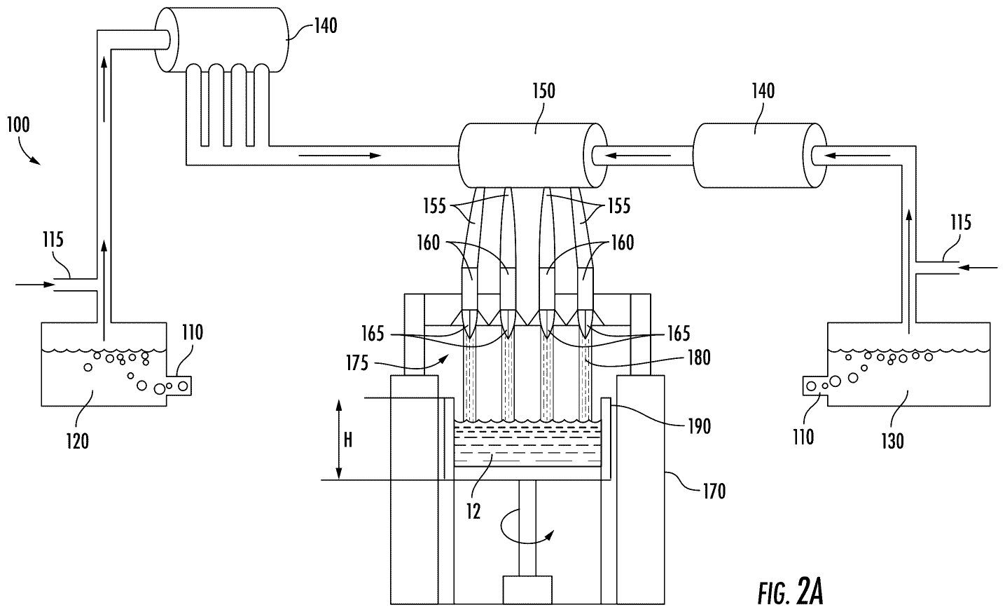

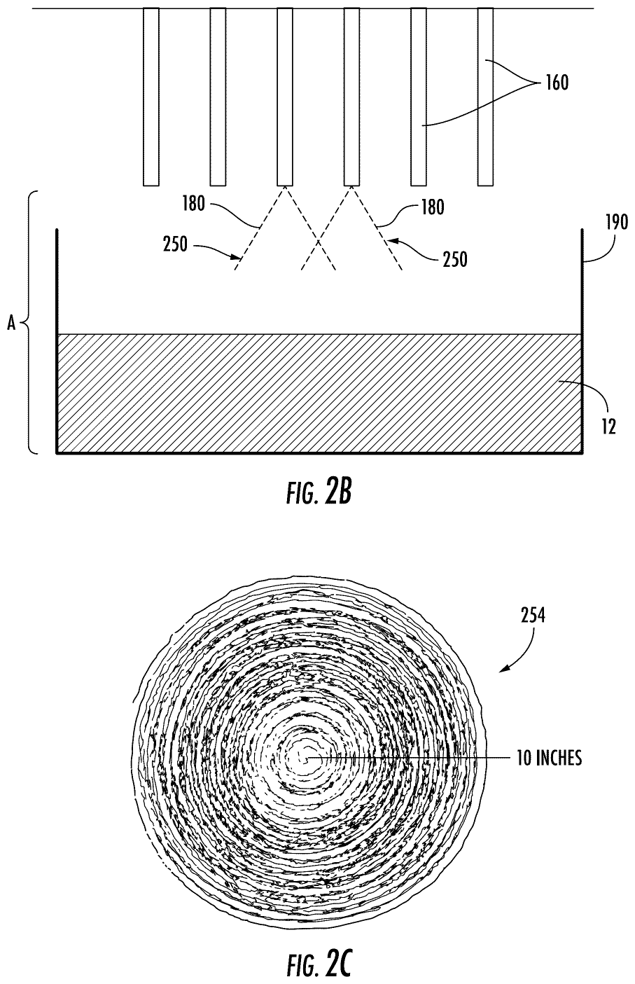

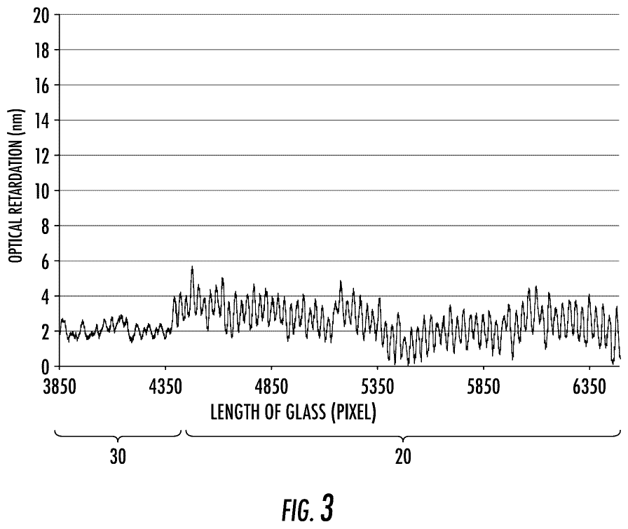

FIG. 2A shows a system 100 for forming silica-titania glass bodies as described herein. System 100 comprises a source of a silica precursor 120 and a source of a titania precursor 130. A carrier gas 110, such as nitrogen, is introduced at or near the base of the source of the silica precursor 120 and the source of the titania precursor 130 to entrain the vapors of the silica precursor 120 and the titania precursor 130 and to carry the vapors through distribution systems 140 to mixing manifold 150. A stream of inert gas 115 (e.g., nitrogen gas) may also be brought into contact with the vaporous silica and titania precursors to prevent saturation of the vapors. The silica precursor 120 and the titania precursor 130 vapors mix in mixing manifold 150 and pass through conduits 155 to burners 160 mounted in an upper portion of a furnace 170. The burners 160 produce burner flames 165 and the mixture is delivered to a conversion site 175 where it is converted into soot particle droplets 180. The soot particle droplets 180 are deposited in a revolving collection cup 190 and onto an upper surface of a forming silica-titania glass body 12 inside furnace 170 where the soot particle droplets consolidate and are annealed into silica-titania glass body 10.

The soot particle droplets 180 comprise silicon dioxide and titanium dioxide. More specifically, the silicon dioxide and titanium dioxide in the particle droplets mix at the atomic level to form Si—O—Ti bonds. Furthermore, the soot particle droplets 180 are spherical in shape with substantially uniform distributions of SiO₂ and TiO₂ within the particles. The size of each soot particle droplet 180 may vary depending on the conditions of burners 160, but in general, soot particle droplets 180 have an average diameter of about 20 nm to about 500 nm, or about 50 nm to about 400 nm, or about 60 nm to about 300 nm, or about 50 nm to about 100 nm.

The silica precursor 120 may comprise, for example, SiCl₄ and/or octamethylcyclotetrasiloxane (OMCTS). The titania precursor 130 may comprise, for example, TiCl₄ or titanium isopropoxide (TPT) (titanium tetraisopropoxide (TTIP), tetraisopropyltitanate (TIPT)).

As shown in FIG. 2B, soot particle droplets 185 are ejected form burners 160 as they are combusted and oxidized from a fuel/oxygen mixture at burners 160. In particular, soot particle droplets 180 are ejected from each burner 160 in an ejection path 250. The soot particle droplets 180 then accumulate in collection cup 190 and are deposited on the growing glass body 10. The particular ejection path 250 of burners 160 provides a smooth and uniform deposition layer of the soot particle droplets 180 in collection cup 190.

In embodiments, each burner 160 of system 100 is configured to move in an oscillating pattern with respect to collection cup 190, thus creating a spiral-like ejection path 250. In other embodiments, collection cup 190 moves in an oscillating pattern with regard to burners 160. The soot particle droplets 180 may be ejected from burners 160 in such an ejection path 250 such that the soot particle droplets are deposited in collection cup 190 in a spiral laydown pattern, such as the spiral laydown pattern 254 as shown in FIG. 2C. It noted that the spiral laydown pattern may be the result of collection cup 190 moving with regard to burners 160 (and, thus, with regard to ejection path 250) or the result of burners 160 (and, thus, ejection path 250) moving with regard to collection cup 190. Therefore, the spiral laydown pattern may have different patterns (e.g., different oscillation and spiral patterns) depending on how the components move with regard to each other. In some embodiments, collection cup 190 moves in a first oscillating pattern with regard to burners 160 to produce a first laydown pattern (thus creating, for example second glass section 30) and then modifies its movement so that it moves in a second oscillating pattern with regard to burners 160 to produce a second laydown pattern (thus creating, for example, first glass section 20). With reference again to FIG. 2B, the ejection path 250 of each burner 160 may overlap, so that the spiral laydown patterns deposited in collection cup 190 may also overlap. The specific laydown pattern affects the uniformity of the produced glass body. For example, patterns with more gaps between the laydown of soot particle droplets 180 results in a less homogeneous glass body. The specific laydown pattern affects the uniformity of the individual deposition layers 22 and 32, with reference to FIG. 1B.

Although FIG. 2B shows six burners 160, it is noted that system 100 may comprise more or less burners 160. For example, system 100 may comprise a single, unitary burner 160. In other embodiments, system 100 may comprise, for example, two, three, four, five, ten, twenty, etc. burners 160.

As discussed above, first glass section 20 may comprise a different compositional variation from second glass section 30 of glass body 10. In particular, first glass section 20 may comprise a different striae content (e.g., magnitude of striae) from second glass section 30 due to the difference in titania concentration between the deposition layers in these sections. In some embodiments, the striae content is controlled by altering the oscillating laydown pattern of the soot particle droplets 180 deposited within collection cup 190. The x-axis and y-axis of the oscillation patterns are defined by the following equations:

$$x ( t ) = {r}_{1} {sin}_{2} {πω}_{1} t + {r}_{2} {sin}_{2} {πω}_{2} t \\ y ( t ) = {r}_{1} {cos}_{2} {πω}_{1} t + {r}_{2} {cos}_{2} {πω}_{2} t$$

wherein x(t) and y(t) represent the coordinates of the center of glass body 10 as a function of time (t) measured in minutes. The parameters r₁, r₂, ω₁, and ω₂ represent a rotation rate of glass body 10 about its center in revolutions per minute (rpm). These parameters are also further described in U.S. Pat. No. 7,053,017, which is incorporated herein by reference in its entirety. In embodiments, the parameters r₁, r₂, ω₁, and ω₂ are each relatively higher when producing second glass section 30 than when producing first glass section 20 in order to produce the reduced striae content in second glass section 30. It has been shown that increasing each of these parameters to 5.0 or greater provides an oscillation laydown pattern that results in reduced striae content. Therefore, embodiments of the present disclosure comprise wherein r₁, r₂, ω₁, and ω₂ are each less than 5.0 (or less than 5.0 and greater than 1.0) to produce first glass section 20. Embodiments of the present disclosure further comprise wherein r₁, r₂, ω₁, and ω₂ are each 5.0 or greater (or between 5.0 and 10.0, or between 5.0 and 8.0) to produce second glass section 30.

In some embodiments, the striae content is controlled by adjusting the distance between collection cup 190 and burners 160, which is shown as distance A in FIG. 2B. In particular, distance A is measured from the end of burners 160 to the bottom cavity of collection cup 190 where the soot particle droplets 180 accumulate. A larger distance A has been shown to produce glass with a reduced or relatively lower striae content. Soot particle droplets that travel relatively larger A distances are typically the first soot laid down during the laydown process. Therefore, these droplets spend a greater amount of time at the forming temperature within collection cup 190, which allows for increased diffusion of the titania among the soot particle droplets. This then leads to more uniform dispersion of titania, which provides a lower striae content.

Therefore, relatively larger A distances may be used to form second glass section 30 of glass body 10 and relatively smaller A distances may be used to from first glass section 20 of glass body 10. Embodiments of the present disclosure comprise producing second glass section 30 before producing first glass section 20 so that second glass section 30 is laid down first within collection cup 190 before first glass section 20.

In some embodiments, the striae content is controlled by controlling the flow of gas through exhaust ports and/or vents in system 100. Plugging or reduction of vents in system 100 was shown to result in more striae in the produced glass body than when operating system 100 with more open vents. Embodiments of the present disclosure comprise operating system 100 with more open vents (e.g., six or more open vents) when producing second glass section 30 than when producing first glass section 20.

FIG. 3 illustrates the optical retardation of first and second glass sections 20, 30 of a glass body produced according to the embodiments disclosed herein. It is noted that the size and spacing of the striae in the glass is directly related to the optical retardation, so that glass with striae having a larger size and with increased spacing would have greater optical retardation. In FIG. 3, the y-axis represents the optical retardation (nm) of the glass, while the x-axis represents a length of the glass as a pixel with a pixel size of about 0.0085 microns per pixel. Second glass section 30 has less optical retardation than first glass section 20, clearly showing that second glass section 30 has reduced striae than first glass section 20.

As discussed above, the titania deposition varies within first and second glass sections 20, 30, thus creating the compositional variation between these layers. A peak-to-valley (P—V) of titania concentration was measured in each glass section to determine the variation in titania deposition between the glass sections. The P—V titania concentration is the difference between the highest concentration of titania and the lowest concentration of titania in a glass body. The lower the P—V value of titania, the more uniform the glass body is with respect to titania concentration.

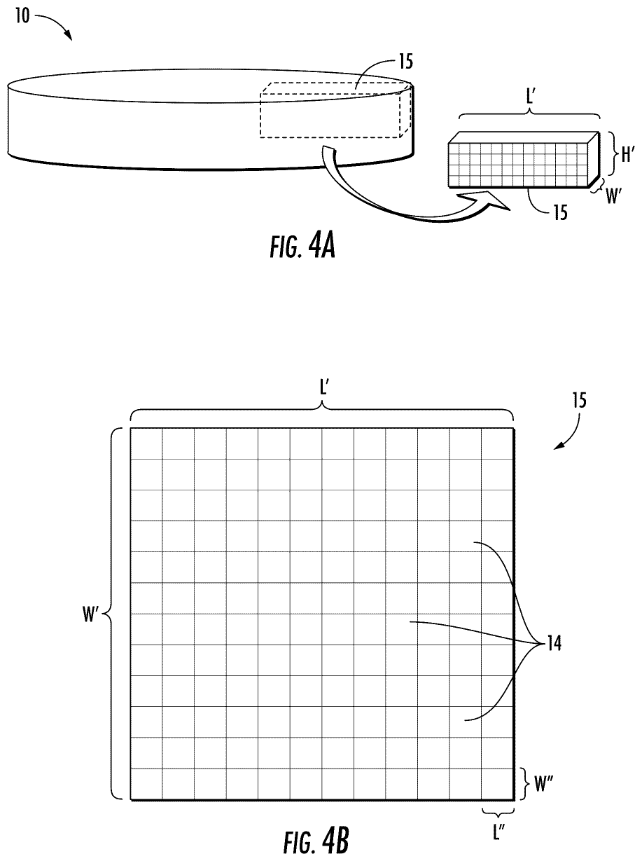

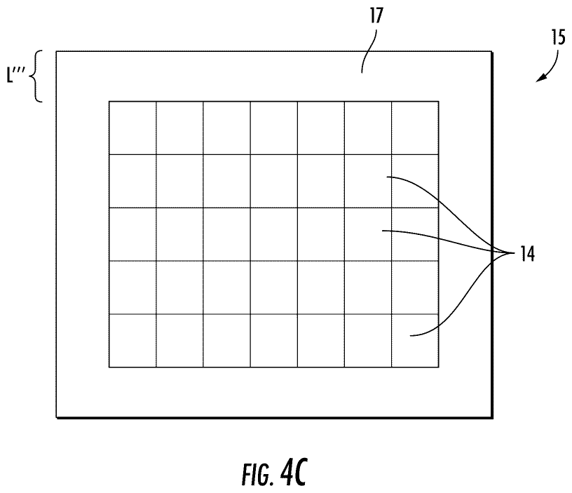

For purposes of the present disclosure, the P—V titania concentration was measured by segmenting the produced glass body into a plurality of segments and measuring the titania concentration of each segment, as discussed below with reference to FIGS. 4A through 4C. FIG. 4A shows a glass body 10 produced according to the embodiments disclosed herein. In the embodiment of FIG. 4A, glass body 10 comprises a cylindrical member.

Glass body 10 may be sliced into a plurality of samples in each of first section 20 and second section 30. FIG. 4A shows an exemplary sample 15 of body 10 that forms a sub-portion of the body. In the embodiment of FIG. 4A, sample 15 is a sub-portion of first section 20. Each sample 15 may also be considered to be a body or a substrate or a wafer. Samples 15 each comprise a length L′, a width W′, and a height H′. Body 10 comprises multiple samples 15 along the height H and/or length L of glass body 10.

Although FIG. 4A depicts sample 15 as being a rectangular component with flat surfaces, it is also contemplated in embodiments that sample 15 may comprise other shapes. For example, the outer profile of sample 15 can be circular or elliptical or a non-symmetrical shape.

Furthermore, sample 15 can be curved forming a concave or convex structure. In some embodiments, sample 15 comprises a single deposition layer 22 in first glass section 20 or a single deposition layer 32 in second glass section 30.

In order to determine the titania concentration uniformity of the samples in a body, each sample is divided into segments across the length and width of the sample. For example, FIG. 4B shows sample 15 divided into segments 14 across the cross-sectional length L′ and width W′ of sample 15. The concentration of one or more components (e.g., titania) may be then determined for each segment 14 in order to determine the uniformity of each of these components along sample 15. As discussed further below, the concentration of the one or more components is determined through the full thickness (height H′) of each segment 14.

Although FIG. 4B shows segments 14 as extending along the entire length L′ and width W′ of sample 15, it is also contemplated that the portion of sample 15 that comprises segments 14 may be less than the entire cross-sectional length L′ and width W′. For example, as shown in FIG. 4C, sample 15 may comprise an outer, peripheral lip 17 upon which segments 14 are not formed. Therefore, outer, peripheral lip 17 may be a clearance between the end of segments 14 and the outer edge of sample 15. In embodiments, the outer, peripheral lip may extend for a length L′″ from about 2 mm to about 20 mm, or about 4 mm to about 16 mm, or about 5 mm to about 16 mm, or about 8 mm to about 14 mm, or about 10 mm to about 12 mm. In some embodiments, the length L′″ is about 12.5 mm or about 12.7 mm.

Segments 14 may be adjacent segments across a specific length and width of sample 15 (such that no gaps are formed between the adjacent segments). As discussed above, this specific length and width (across which all the segments 14 extend) may be equal to or less than the length L′ and width W′ of sample 15. In embodiments, segments 14 are adjacent segments across a length and width (across which all the segments 14 extend) of sample 15 such that the length and width are each about 25 mm or greater, or about 30 mm or greater, or about 40 mm or greater or about 50 mm or greater, or about 60 mm or greater, or about 75 mm or greater, or about 100 mm or greater, or about 125 mm or greater, or about 150 mm or greater, or about 175 mm or greater, or about 180 mm or greater, or about 190 mm or greater, or about 200 mm or greater, or about 250 mm or greater.

When sample 15 comprises a flat surface, segments 14 are formed along the flat planar surface, as shown in FIG. 4B. However, when sample 15 comprises a concave or convex surface, segments 14 are formed along the curving surface of sample 15.

As shown in FIG. 4B, each segment 20 has a length L″ and a width W″ that are each about 12.7 mm. However, it is also contemplated in other embodiments that the length L″ is not equal to the width W″. It is also noted that in some embodiments, the length L″ and the width W″ of segments 14 may be equal to the length L′″ of peripheral lip 17.

The height of each segment 14 is the height H′ of sample 15, as discussed above. Therefore, in embodiments, the height H′ is about 7.62 mm.

As discussed above, the concentration of one or more components may be determined within each segment 14. Therefore, for example, the concentration of titania may be determined for each adjacent segment 14 within sample 15. When each segment 14 has a length and width of 12.7 mm, the concentration of the components is determined at a frequency of 12.7 mm across the cross-section of sample 15. For example, the concentration of titania is measured at a frequency of 12.7 mm across the cross-section of sample 15.

One or more segments 14 may have a different concentration of titania from one or more other segments 14. An average titania concentration along the length L′ and width W′ of sample 15 may be determined by averaging together the titania concentrations of the individual segments 14. The average titania concentration amongst segments 14 (in each of first glass section 20 and second glass section 3 is from about 1.0 wt. % to about 15.0 wt. %, or from about 6.0 wt. % to about 12.0 wt. %, or from about 6.0 wt. % to about 8.5 wt. %, or from about 6.0 wt. % to about 8.0 wt. %, or from about 6.0 wt. % to about 7.5 wt. %, or from about 6.0 wt. % to about 7.0 wt. %, or about 6.0 wt. % to about 6.8 wt. %, or about 6.0 wt. % to about 6.5 wt. %, as also discussed above with reference to glass body 10.

The difference between the highest concentration and the lowest concentration of titania amongst the different segments 14 is the P—V titania concentration. More specifically, the segment 14 with the highest titania concentration is compared with the segment 14 with the lowest titania concentration. Then, the difference between the highest and lowest OH titania concentrations is calculated. This difference between the highest concentration and the lowest concentration in a sample 15 is referred to as the P—V difference in concentration. The lower the P—V difference, the more uniform the concentration is in a particular sample.

The P—V difference of titania concentration of segments 14 in sample 15 when sample 15 comprises a single deposition layer 22 or 32 is be about 0.0200 wt. % or less, or about 0.01500 wt. % or less, or about 0.0100 wt. % or less, or about 0.0090 wt. % or less, or about 0.0080 wt. % or less, or about 0.0070 wt. % or less, or about 0.0060 wt. % or less, or about 0050 wt. % or less, or about 0.0040 wt. % or less, or about 0.0035 wt. % or less, or about 0.0030 wt. % or less, or about 0.0025 wt. % or less, or about 0.0020 wt. % or less, or about 0.0015 wt. % or less, or about 0.0010 wt. % or less. In embodiments, the P—V difference of titania concentration of segments 14 in sample 15 when sample 15 comprises a single deposition layer 22 or 32 is in range from about 0.0010 wt. % to about 0.0050 wt. %, or about 0.0015 wt. % to about 0.0045 wt. %, or about 0.0020 wt. % to about 0.0040 wt. %, or about 0.0025 wt. % to about 0.0035 wt. %, or about 0.0030 wt. % to about 0.0050 wt. %, or about 0.0010 wt. % to about 0.0030 wt. %, or about 0.0010 wt. % to about 0.0025 wt. %, or about 0.0010 wt. % to about 0.0020 wt. %. In embodiments, the P—V of titania concentration in deposition layer 32 in second glass section 30 is less than the P—V difference of titania concentration in deposition layer 22 of first glass section 20. The P—V difference of titania concentration in glass body 10 is very low, thus embodiments disclosed herein produce a homogenous glass body 10 with a uniform concentration of titania.

The P—V difference of refractive index of segments 14 across sample 15 when sample 15 comprises a single deposition layer 22 or 32 is be about 1×10¹ or less, or about 5×10⁻⁵ or less, or about 1×10⁻⁵ or less, or about 5×10⁴ or less, or about 1×10⁻⁶ or less, or about 5×10⁻⁷ or less, or about 1×10⁻⁷ or less, or from about 1×10⁻⁶ to about 1×10⁻⁴, or about 6×10⁻⁶ to about 9×10⁻⁵, or about 10×10⁻⁶ to about 6×10⁻⁵, or about 1×10⁻⁶ to about 1×10⁻⁵, or about 1×10⁻⁵ to about 1×10⁻⁴. The distribution of refractive index within a glass substrate is an indicator of the titania concentration distribution of that glass substrate. Therefore, a glass substrate with a smaller P—V difference in refractive index will also have a smaller P—V difference of titania concentration. As discussed above, a smaller P—V difference of titania allows the glass substrate to be more uniformly polished.

Embodiments of the present disclosure also comprise methods to produce a monolithic glass body 10 comprising first glass section 20 and second glass section 30 without a seal plane therebetween. Therefore, the monolithic glass body 10 does not have such deformation that can arise at a seal plane. Instead, first glass section 20 and second glass section 30 are formed continuously from the same soot laydown process. In embodiments, second glass section 30 is formed before first glass section 20. In some embodiments, glass body 10 consists of first glass section 20 and second glass section 30.

According to a first aspect, a titania and silica glass body comprising a first glass section having a crossover temperature of about 10° C. to about 60° C., and a second glass section comprising an average striae height of about 10 microns or less, wherein the average striae height of the second glass section is less than an average striae height of the first glass section, and wherein the first glass section and the second glass section form a single, monolithic glass body.

According to a second aspect, the titania and silica glass body of the first aspect, wherein the average striae height of the second glass section is about 1 micron or less.

According to a third aspect, the titania and silica glass body of the second aspect, wherein the average striae height of the second glass section is about 50 nm or less.

According to a fourth aspect, the titania and silica glass body of the first aspect, wherein the average striae height of the first glass section is about 1 mm or less.

According to a fifth aspect, the titania and silica glass body of the first aspect, wherein the glass body has a titania concentration from about 6.0 wt. % to about 8.5 wt. %.

According to a sixth aspect, the titania and silica glass body of the fifth aspect, wherein the titania concentration is from about 6.0 wt. % to about 6.8 wt. %.

According to a seventh aspect, the titania and silica glass body of the first aspect, wherein the crossover temperature is from about 20° C. to about 40° C.

According to an eight aspect, the titania and silica glass body of the first aspect, wherein the first glass section has a coefficient of thermal expansion from about −10 ppb/° C. to about +10 ppb/° C. within the temperature range between 15° C. and 30° C.

According to a ninth aspect, the titania and silica glass body of the first aspect, wherein the glass body slope of CTE at 20° C. in a range from about 1.0 ppb/K² to about 2.5 ppb/K².

According to a tenth aspect, the titania and silica glass body of the first aspect, wherein a height of first glass section is about 60% or more a height of the glass body.

According to an eleventh aspect, the titania and silica glass body of the first aspect, wherein a height of second glass section is about 10 mm to about 75 mm.

According to a twelfth aspect, the titania and silica glass body of the first aspect, wherein an average spacing between striae in second glass section is less than an average spacing between striae in first glass section.

According to a thirteenth aspect, the titania and silica glass body of the first aspect, wherein the second glass section does not comprise striae.

According to a fourteenth aspect, the titania and silica glass body of the thirteenth aspect, wherein the first glass section comprises striae.

According to a fifteenth aspect, the titania and silica glass body of the first aspect, wherein the glass body consists of the first glass section and the second glass section.

According to a sixteenth aspect, the titania and silica glass body of the first aspect, wherein the glass body is a photomask or a mirror.

According to a seventeenth aspect, a method of producing a glass body, the method comprising ejecting titania-silica soot particle droplets from a burner of a furnace in a collection cup, the titania-silica soot particle droplets being ejected in a laydown pattern in the collection cup to form a first glass section, modifying the laydown pattern of the titania-silica soot particle droplets to form a second glass section, and consolidating the titania-silica soot particle droplets in the collection cup, wherein the first glass section and the second glass section comprise a single, monolithic glass body, and wherein the average striae height of the second glass section is less than an average striae height of the first glass section.

According to an eighteenth aspect, the method of the seventeenth aspect, wherein modifying the laydown pattern of the titania-silica soot particle droplets comprises moving the collection cup relative to the burner so that the laydown pattern changes from a first spiral-like pattern to a second spiral-like pattern.

According to a nineteenth aspect, the method of the seventeenth aspect, wherein modifying the laydown pattern of the titania-silica soot particle droplets causes titania deposition layers in the first glass section to be thicker than titania deposition layers in the second glass section.

According to a twentieth aspect, the method of the seventeenth aspect, further comprising forming the glass body comprised of the first glass section and the second glass section without bonding the first glass section to the second glass section.

It will be apparent to those skilled in the art that various modifications and variations can be made to embodiments of the present disclosure without departing from the spirit and scope of the disclosure. Thus, it is intended that the present disclosure cover such modifications and variations provided they come within the scope of the appended claims and their equivalents.

What is claimed is:

1. A titania and silica glass body comprising:
a first glass section having a crossover temperature of about 10° C. to about 60° C.; and
a second glass section comprising an average striae height of about 10 microns or less,
wherein the average striae height of the second glass section is less than an average striae height of the first glass section, and
wherein the first glass section and the second glass section form a single, monolithic glass body.

2. The titania and silica glass body of claim 1, wherein the average striae height of the second glass section is about 1 micron or less.

3. The titania and silica glass body of claim 2, wherein the average striae height of the second glass section is about 50 nm or less.

4. The titania and silica glass body of claim 1, wherein the average striae height of the first glass section is about 1 mm or less.

5. The titania and silica glass body of claim 1, wherein the glass body has a titania concentration from about 6.0 wt. % to about 8.5 wt. %.

6. The titania and silica glass body of claim 5, wherein the titania concentration is from about 6.0 wt. % to about 6.8 wt. %.

7. The titania and silica glass body of claim 1, wherein the crossover temperature is from about 20° C. to about 40° C.

8. The titania and silica glass body of claim 1, wherein the first glass section has a coefficient of thermal expansion from about −10 ppb/° C. to about +10 ppb/° C. within the temperature range between 15° C. and 30° C.

9. The titania and silica glass body of claim 1, wherein the glass body has a slope of CTE at 20° C. in a range from about 1.0 ppb/K² to about 2.5 ppb/K².

10. The titania and silica glass body of claim 1, wherein a height of the first glass section is about 60% or more of a height of the glass body.

11. The titania and silica glass body of claim 1, wherein a height of the second glass section is about 10 mm to about 75 mm.

12. The titania and silica glass body of claim 1, wherein an average spacing between striae in the second glass section is less than an average spacing between striae in the first glass section.

13. The titania and silica glass body of claim 1, wherein the second glass section does not comprise striae.

14. The titania and silica glass body of claim 13, wherein the first glass section comprises striae.

15. The titania and silica glass body of claim 1, wherein the glass body consists of the first glass section and the second glass section.

16. The titania and silica glass body of claim 1, wherein the glass body is a photomask or a mirror.

17. A method of producing a glass body, the method comprising:
ejecting titania-silica soot particle droplets from a burner of a furnace in a collection cup, the titania-silica soot particle droplets being ejected in a laydown pattern in the collection cup to form a first glass section;
modifying the laydown pattern of the titania-silica soot particle droplets to form a second glass section; and
consolidating the titania-silica soot particle droplets in the collection cup,
wherein the first glass section and the second glass section comprise a single, monolithic glass body, and
wherein the average striae height of the second glass section is less than an average striae height of the first glass section.

18. The method of claim 17, wherein modifying the laydown pattern of the titania-silica soot particle droplets comprises moving the collection cup relative to the burner so that the laydown pattern changes from a first spiral-like pattern to a second spiral-like pattern.

19. The method of claim 17, wherein modifying the laydown pattern of the titania-silica soot particle droplets causes titania deposition layers in the first glass section to be thicker than titania deposition layers in the second glass section.

20. The method of claim 17, further comprising forming the glass body comprised of the first glass section and the second glass section without bonding the first glass section to the second glass section.
